(19) United States
(12) Patent Application Publication
(10) Pub. No.: US 2022/0327865 A1
(43) Pub. Date: Oct. 13, 2022

(54) ELECTRONIC DEVICE AND CONTROL METHOD

(71) Applicant: SHARP KABUSHIKI KAISHA, Osaka (JP)

(72) Inventor: Natsuki UCHIDA, Osaka (JP)

(21) Appl. No.: 17/714,755

(22) Filed: Apr. 6, 2022

(30) Foreign Application Priority Data
Apr. 8, 2021 (JP) 2021-065662

(51) Int. Cl. G06V 40/16; G06V 10/762; G06V 10/74; G06T 3/40

(52) U.S. Cl. CPC G06V 40/172; G06V 40/168; G06V 10/762; G06V 10/761; G06T 3/40

(57) ABSTRACT

An electronic device includes a storage unit configured to store a still image, and a control unit. The control unit calculates a feature of each one of a plurality of faces included in the still image, groups the features of the plurality of faces into one or more groups by clustering on the basis of similarity of the features, selects one feature from the features included in each group of the one or more groups, stores registered face information including the selected feature of each group in the storage unit, calculates a feature of at least one face included in a moving image, and executes predetermined processing on the moving image on the basis of the feature of the at least one face included in the moving image and the registered face information.

### CROSS-REFERENCE TO RELATED APPLICATIONS

This application claims the benefit of priority to Japanese Patent Application Number 2021-065662 filed on Apr. 8, 2021. The entire contents of the above-identified application are hereby incorporated by reference.

### BACKGROUND

### Technical Field

The disclosure relates to an electronic device and a control method.

A known image processing device can automatically extract a preferred portion for a digest from a portion corresponding to a recording date and time of a still image from a moving image (see JP 2013-239797 A, for example).

### SUMMARY

With known techniques, it is difficult to determine whether a person included in a moving image is a person who is friendly with a user. Therefore, processing to automatically magnify the display of a person who is friendly with the user and processing to automatically extract a scene showing a person who is friendly with the user are difficult to achieve.

An aspect of the disclosure is directed at providing an electronic device that executes a predetermined processing on the basis of whether a person included in a moving image is a person who is friendly with a user.

An electronic device according to an aspect of the disclosure includes a storage unit configured to store a still image; and a control unit, wherein the control unit calculates a feature of each one of a plurality of faces included in the still image, groups the features of the plurality of faces into one or more groups by clustering on the basis of similarity of the features, selects one feature from the features included in each group of the one or more groups, stores registered face information including the selected feature of each group in the storage unit, calculates a feature of at least one face included in a moving image, and executes predetermined processing on the moving image on the basis of the feature of the at least one face included in the moving image and the registered face information.

A control method according to an aspect of the disclosure includes processing to calculate a feature of each one of a plurality of faces included in a still image; group the features of each one of the plurality of faces into one or more groups by clustering on the basis of similarity of the features; select one feature from the features included in each group of the one or more groups; store registered face information including the selected feature of each group in the storage unit; calculate a feature of at least one face included in a moving image; and execute predetermined processing on the moving image on the basis of the feature of the at least one face included in the moving image and the registered face information.

### BRIEF DESCRIPTION OF DRAWINGS

The disclosure will be described with reference to the accompanying drawings, wherein like numbers reference like elements.

FIG. 1 is an example of a configuration diagram of an electronic device according to a first embodiment.

FIG. 2 is an example of a flowchart of processing to generate registered face information according to the first embodiment.

FIG. 3 is a diagram for describing a still image and clustering of facial features.

FIG. 4 is a diagram for describing the generation of registered face information based on clustering of facial features.

FIG. 5A is a flowchart illustrating display processing of the electronic device according to the first embodiment.

FIG. 5B is a flowchart illustrating the display processing of the electronic device according to the first embodiment.

FIG. 6 is a diagram illustrating a display example of a display unit of the electronic device according to the first embodiment.

FIG. 7 is a diagram illustrating a display example of the display unit of the electronic device according to the first embodiment.

FIG. 8 is an example of a configuration diagram of an electronic device according to a second embodiment.

FIG. 9 is a flowchart illustrating marking processing of the electronic device according to the second embodiment.

### DESCRIPTION OF EMBODIMENTS

Embodiments will be described hereinafter with reference to the drawings. In the drawings, identical or equivalent elements are given the same reference signs, and redundant descriptions thereof are omitted.

### First Embodiment

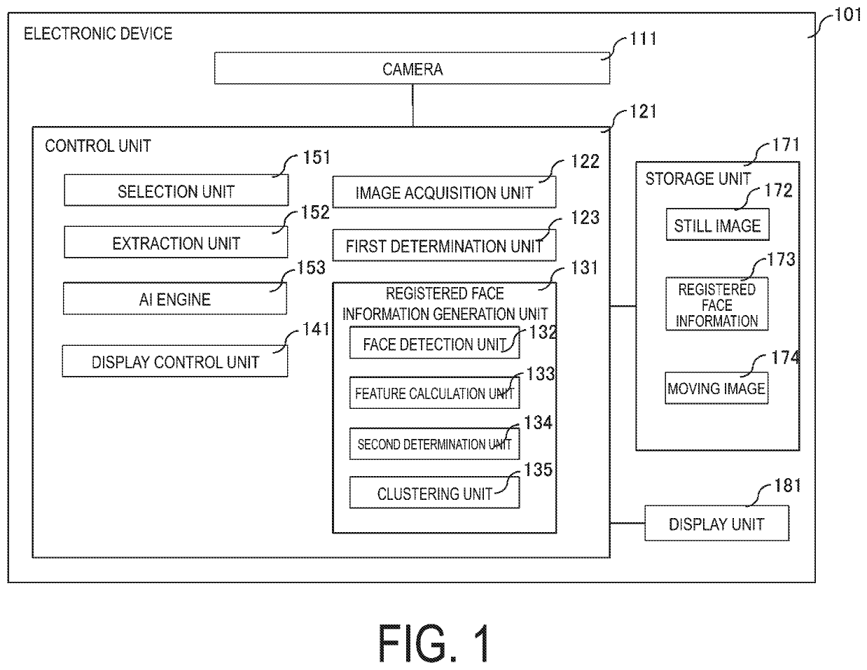

FIG. 1 is an example of a configuration diagram of an electronic device according to the first embodiment.

An electronic device 101 includes a camera (image capture unit) 111, a control unit 121, a storage unit 171, and a display unit 181. The electronic device 101 is a smartphone, a tablet, or a personal computer (PC), for example.

The camera 111 includes an imaging element, such as a charge coupled device (CCD) or a complementary metal oxide semiconductor (CMOS), and can capture still images and moving images.

The control unit 121 controls the electronic device 101. The control unit 121 can execute various types of application software (not illustrated) stored in the storage unit 171. The control unit 121 includes an image acquisition unit 122, a first determination unit 123, a registered face information generation unit 131, a display control unit 141, a selection unit 151, an extraction unit 152, and an AI engine 153. The control unit 121 is, for example, a processor such as a central processing unit (CPU), or a logic circuit (hardware) formed on an integrated circuit (IC) or the like.

The image acquisition unit 122 acquires a still image captured by the camera 111 and stores a still image 172 in the storage unit 171. Additionally, the image acquisition unit 122 acquires a moving image (video) captured by the camera 111 and stores a moving image 174 in the storage unit 171.

The first determination unit (still image determination unit) 123 determines whether there is an unprocessed still image 172. Specifically, the first determination unit 123 determines whether there is a still image 172 for which it has not been determined whether a face is present by a face detection unit 132 to be described below. Furthermore, the first determination unit 123 determines whether a trigger for generating registered face information 173 has been triggered.

The registered face information generation unit 131 generates the registered face information 173 on the basis of the still image 172. The registered face information generation unit 131 includes the face detection unit 132, a feature calculation unit 133, a second determination unit 134, and a clustering unit 135.

The face detection unit 132 detects a face that is present in the still image 172. Specifically, the face detection unit 132 determines whether a face is present in the still image 172 and, in a case where a face is determined to be present, detects the position of the face (for example, coordinates indicating a rectangular region including the face). Note that in a case where a plurality of faces are present in the still image 172, the face detection unit 132 detects the position of each face.

The feature calculation unit 133 calculates features (facial features) of the face detected by the face detection unit 132 (in other words, the face at the position detected by the face detection unit 132). The facial features are, for example, values obtained by converting the features of the face to numerical values, and is a feature vector including a plurality of values as elements. For example, the positions of the parts of the face (eyes, nose, mouth, and the like) and the shape of the contour line of the jaw are expressed as numerical values and formed into a feature vector by the feature calculation unit 133.

The second determination unit (facial feature determination unit) 134 determines whether the number of facial features calculated by the feature calculation unit 133 is equal to or greater than a threshold value. The threshold value is predetermined and is 3, for example. Note that the threshold value is not limited to 3 and need only be an integer of 1 or greater.

The clustering unit 135 performs clustering on the basis of the similarity between facial features and groups the facial features into one or more groups. For each group, the clustering unit 135 selects one facial feature included in the group (the selected facial feature being referred to as a “representative vector”), associates the selected representative vector with a priority, and stores these in the storage unit 171 as the registered face information 173. The priority is used as, for example, a criterion for determining which face of a person to apply a process such as a predetermined process (for example, zoom-in) to in a case where a plurality of faces are present in a frame of the moving image 174. The greater the number of facial features included in the group, the higher the priority. For example, the priority associated with a representative vector corresponds to the number of facial features included in the group including the representative vector.

The display control unit 141 controls the display of the display unit 181 and, for example, displays the still image and the moving image 174 stored in the storage unit 171 on the display unit 181. When zoom region information is acquired from the selection unit 151, the display control unit 141 references the zoom region information, zooms in on (magnifies) the region including the subject corresponding to the magnified display target, and displays the moving image 174 on the display unit 181. The zoom region information includes the range of the region including the subject and the magnification ratio of the region.

The selection unit 151 executes processing to reference information relating to each subject included in the moving image 174 and select the magnified display target from the subjects included in the moving image 174. Specifically, in the processing to select the magnified display target, the selection unit 151 uses a recognition result of the AI engine 153 acquired from the extraction unit 152 to select a zoom region in the moving image 174 and generates the zoom region information including the range of the zoom region. Then, the selection unit 151 sets the magnification ratio of the region including the subject selected as the magnified display target, adds the magnification ratio to the zoom region information, and outputs the zoom region information to the display control unit 141.

The extraction unit 152 executes processing to extract the subject included in the moving image 174 and subject information (information) relating to each subject from the moving image 174 stored in the storage unit 171. The subject information includes at least one of the name of the subject, the size of the subject, the position of the subject, whether the subject has a face, the facial expression of the subject, the movement of the subject, the orientation of the subject, the number of subjects, the brightness of the subject, or composition information of the subject. Specifically, the extraction unit 152 functions to control the AI engine 153 and cause the AI engine 153 to analyze the moving image 174, and outputs the recognition result of the AI engine 153 to the selection unit 151.

Note that the name of the subject includes the type of the subject (person, dog, cat, or the like) and may include the individual name of the subject in a case where the subject is a person.

Furthermore, the composition information of the subject is composition information of a frame of the moving image, and refers to the quality of the composition in terms of the subject and the background of the subject. More specifically, the composition information preferably includes an evaluation value relating to the composition.

The AI engine 153 analyzes the moving image 174 and outputs the recognition result relating to the subject included in the moving image 174 to the selection unit 151 via the extraction unit 152. For example, the AI engine 153 performs composition determination for the moving image 174. The composition determination is to determine whether the evaluation value relating to the composition of the post-zoom image is equal to or greater than a predetermined value. The AI engine 153 learns an image that is recognized as having a generally good composition and assigns a high score (evaluation value) to the moving image 174 that is similar to this image. The AI engine 153 performs object recognition for the moving image 174. The object recognition is to recognize a specific object, such as a person, dog, cat, or the like in the moving image 174.

The storage unit 171 stores data, programs, and the like used by the electronic device 101. The storage unit 171 is, for example, a storage device such as a flash memory or a hard disk drive (HDD). The storage unit 171 may also be a portable recording medium such as an SD memory card or a USB memory. The storage unit 171 stores the still image 172, the registered face information 173, and the moving image 174.

The still image 172 is, for example, image data of a still image captured by the camera 111. Furthermore, the still image 172 may be a plurality of still images, and, when the still image 172 is a plurality (numbering m for example), the plurality of still images 172 may be denoted as “still images 172-1 to 171-m”.

The registered face information 173 is information generated on the basis of the features of the face included in the still image 172. The registered face information 173 includes, for example, a feature of the face of a person who is friendly with the user of the electronic device 101. Details of the registered face information 173 will be described below.

The moving image 174 is moving image data including a plurality of frames captured by the camera 111, for example.

The display unit 181 displays the still image 172 and the moving image 174. The display unit 181 functions as an electronic viewfinder when capturing the still image 172 and the moving image 174. The display unit 181 is, for example, a liquid crystal panel or an organic EL panel. Furthermore, the display unit 181 includes a touch panel function and can receive input of an operation by a user.

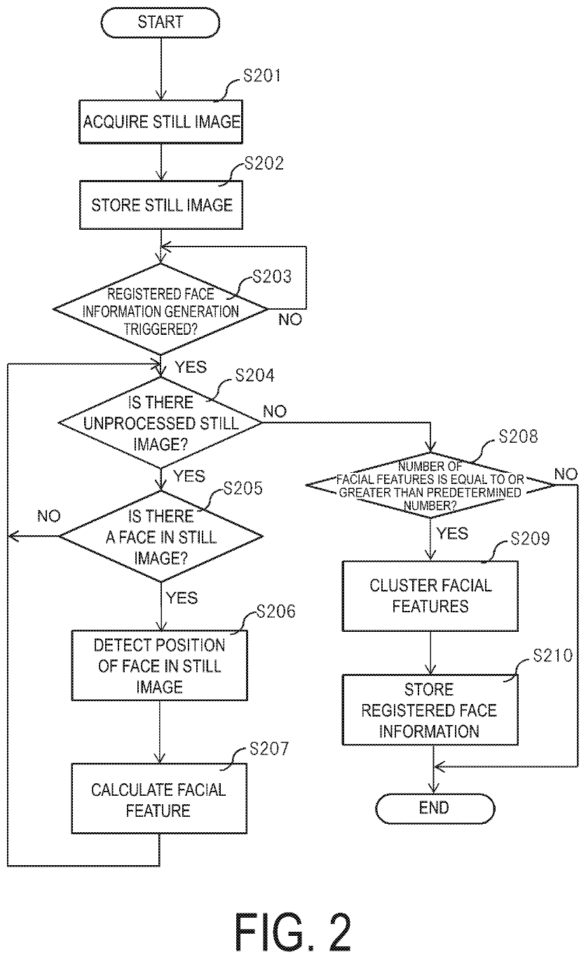

Next, the generation of the registered face information 173 will be described with reference to FIGS. 2 to 4.

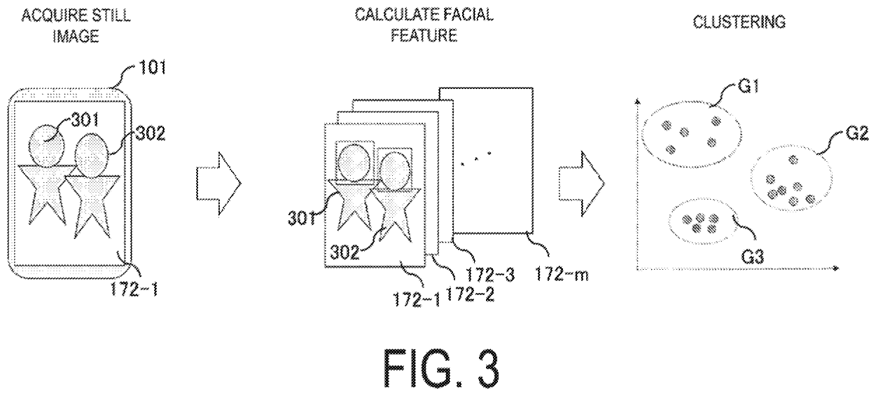

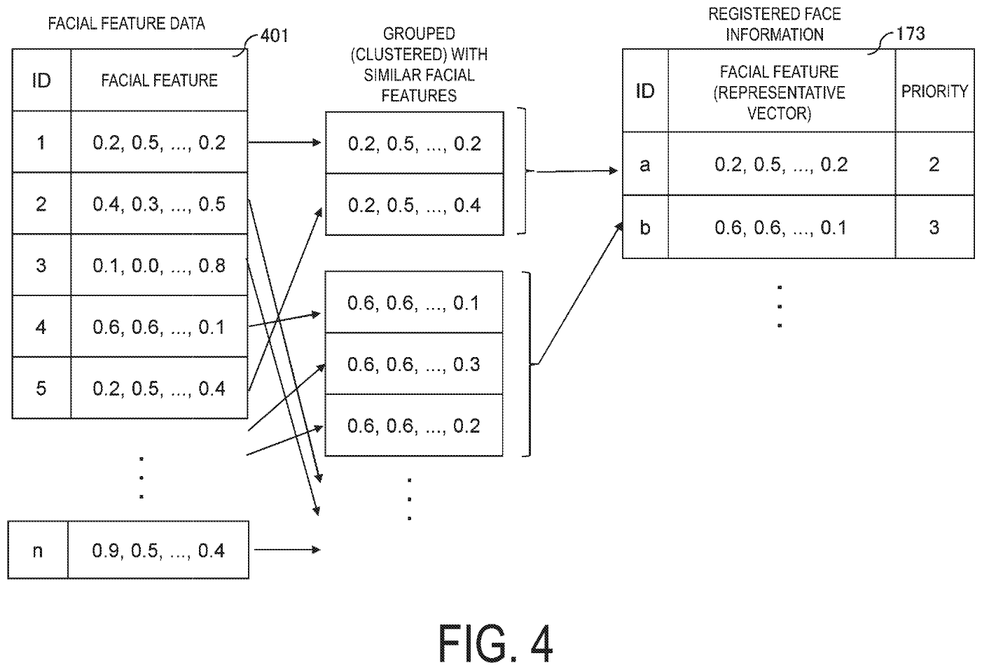

FIG. 2 is an example of a flowchart of the processing to generate registered face information according to the first embodiment. FIG. 3 is a diagram for describing the still image and clustering of the facial features. FIG. 4 is a diagram for describing the generation of registered face information based on clustering of the facial features.

In step S201, in response to an input operation by a user, the image acquisition unit 122 runs an application software to capture the still image 172 using the camera 111, captures the still image 172 using the camera 111, and acquires the still image 172 from the camera 111. For example, as illustrated on the left side of FIG. 3, the still image 172-1, in which persons 301 and 302 are present, is captured.

In step S202, the image acquisition unit 122 stores the acquired still image 172 in the storage unit 171. Steps S201 and S202 are repeated each time the user captures the still image 172 from when the user starts the application software for capturing the still image 172 until the user ends the application software. Herein, a case will be described where, as illustrated in the center of FIG. 3, the still images 172-1 to 172-m are captured and stored in the storage unit 171. When the user finishes capturing images, the user performs an input operation for ending the application software for capturing the still image 172, and the image acquisition unit 122 ends the application software.

In step S203, the image acquisition unit 122 determines whether the trigger for generating the registered face information 173 has been triggered, and, in a case where it is determined to have been triggered, the control proceeds to step S204. The image acquisition unit 122 repeats the determination of whether the trigger for generating the registered face information 173 has been triggered until it is determined that the trigger has been triggered. The trigger for generating the registered face information 173 is, for example, when the electronic device 101 starts charging, when the current time reaches a predetermined time, or the like. Thus, the image acquisition unit 122 determines that the trigger for generating the registered face information 173 has been triggered in a case where, for example, charging of the electronic device 101 starts, the current time reaches a predetermined time, or the like.

In step S204, the first determination unit 123 determines whether there is an unprocessed still image among the still images 172 stored in the storage unit 171. Specifically, the first determination unit 123 determines whether, among the still images 172-1 to 172-m stored in the storage unit 171, there is a still image for which it has not been determined whether a face is present in step S205. In a case where it is determined that there is an unprocessed still image (in other words, that there is a still image for which it has not been determined whether a face is present in step S205) (YES in step S204), the control proceeds to step S205. In a case where it is determined that there are no unprocessed still images (that there are no still images for which it has not been determined whether a face is present in step S205) (NO in step S204), the control proceeds to step S208.

In step S205, the face detection unit 132 selects a single still image from the unprocessed still images (from the still images 172-1 to 172-m stored in the storage unit 171 for which it has not been determined whether a face is present in step S205) and determines whether a face is present in the selected still image. In a case where it is determined that a face is present (YES in step S205), the control proceeds to step S206. In a case where it is determined that a face is not present (NO in step S205), the control returns to step S204.

In step S206, the face detection unit 132 detects the position of the face in the still image for which it has been determined that a face is present in step S205. Note that in a case where a plurality of faces are present in the still image, the face detection unit 132 detects the position of each face. The position of the face is, for example, coordinates indicating a rectangular region including the face, and as in the still image 172-1 illustrated in the center of FIG. 3, coordinates indicating rectangular regions including the faces of persons 301 and 302 are detected as the position of the face.

In step S207, the feature calculation unit 133 calculates the feature (facial feature) of the face on the basis of the position of the face detected in step S206. Note that, in a case where the positions of a plurality of faces are detected in step S206, the feature calculation unit 133 calculates the facial feature of each of the faces on the basis of the respective position of each face. The feature calculation unit 133 stores, in the storage unit 171, the facial feature data in which the calculated facial features and an ID are associated. The ID is identification information for identifying the faces included in the still images 172-1 to 172-m, and the feature calculation unit 133 assigns different IDs for each face.

By executing the processing of steps S204 to S207 on the still images 172-1 to 172-m, facial feature data 401 such as that illustrated on the left side in FIG. 4 in which the facial features of the faces included in the still images 172-1 to 172-m and the IDs are associated is generated. For example, in a case where n number of faces are present in the still images 172-1 to 172-m, as illustrated in FIG. 4, the facial feature data 401 including n number of facial features is generated. Also, the facial features of the facial feature data 401 are a k-dimensional feature vector including k number of elements.

In step S208, the second determination unit 134 determines whether the number of facial features included in the facial feature data 401 is equal to or greater than a threshold value. The threshold value is predetermined and is 3, for example. Note that the threshold value is not limited to being 3 and need only be an integer of 1 or greater. In a case where it is determined that the number of facial features is equal to or greater than the threshold value, the control proceeds to step S209. In a case where it is determined that the number of facial features is less than the threshold value, processing to generate registered face information ends.

In step S209, the clustering unit 135 groups the plurality of facial features included in the facial feature data 401 into one or more groups by clustering on the basis of the similarity between facial features. In other words, the clustering unit 135 groups facial features with a high similarity into the same group. The similarity between facial features is, for example, the Euclidean distance between facial features. The shorter the Euclidean distance between facial features, the higher the similarity between facial features. For example, the facial features of the face of the same person are included in the same group due to the facial features having a high similarity.

Herein, an example of the result of clustering will be described. The figure on the right side of FIG. 3 is a diagram schematically illustrating the facial features as two-dimensional vectors to facilitate understanding of the clustering result. Each point represents a facial feature. As illustrated on the right side of FIG. 3, facial features with high similarity are grouped in the same group, and the facial features are grouped into one of groups G1 to G3.

In step S210, the clustering unit 135, on the basis of the facial features grouped in step S209, generates the registered face information 173 and stores the registered face information 173 in the storage unit 171. Specifically, the clustering unit 135 selects one facial feature from the facial features included in each group and associates together and stores the ID indicating the group, the selected facial feature (representative vector), and the priority in the storage unit 171 as the registered face information 173. Note that the clustering unit 135 may discretionarily select one facial feature selected from the group. The clustering unit 135 selects, for example, a facial feature corresponding to the smallest ID from among the facial features included in the group. Also, the clustering unit 135 may, instead of selecting one facial feature from the facial features included in each group, calculate the average value or the median of the facial features included in each group and associate together and store the calculated average value or median and the priority in the storage unit 171 as the registered face information 173. The priority is determined on the basis of the number of facial features included in the group, and the greater the number of facial features included in the group, the higher the priority. For example, the priority associated with a representative vector corresponds to the number of facial features included in the group including the representative vector. As the priority corresponding to the facial feature increases, it is more likely that the person with the face including facial features is a person that often appears in the still images 172 and that the person is friendly with the user of the electronic device 101.

As illustrated in the center of FIG. 4, the facial feature (0.2, 0.5, . . . , 0.2) corresponding to the ID of 1 in the facial feature data 401 and the facial feature (0.2, 0.5, . . . , 0.4) corresponding to the ID of 5 are grouped into the same group (group a). The clustering unit 135 selects the facial feature (0.2, 0.5, . . . , 0.2) corresponding to the ID of 1 as the single facial feature from the facial features included in the group a, and sets the number of facial features included in the group a, i.e., 2, as the priority. As illustrated on the right side of FIG. 4, the clustering unit 135 associates together an ID of a indicating the group a, the facial feature (0.2, 0.5, . . . 0.2) corresponding to the selected ID of 1, and the priority of 2, and stores these as the registered face information 173 in the storage unit 171.

In a similar manner, as illustrated in the center of FIG. 4, the facial feature (0.6, 0.6, . . . , 0.1) corresponding to the ID of 4 in the facial feature data 401, the facial feature (0.6, 0.6, . . . , 0.3), and the facial feature (0.6, 0.6, . . . , 0.2) are grouped into the same group (group b). The facial feature (0.6, 0.6, . . . , 0.1) corresponding to the ID of 4 is selected from the group b, and the number of facial features included in the group b, i.e., 3, is set as the priority. Then, an ID of b indicating the group b, the facial feature (0.6, 0.6, . . . 0.1) corresponding to the selected ID of 4, and the priority of 3 are associated together and stored as the registered face information 173 in the storage unit 171.

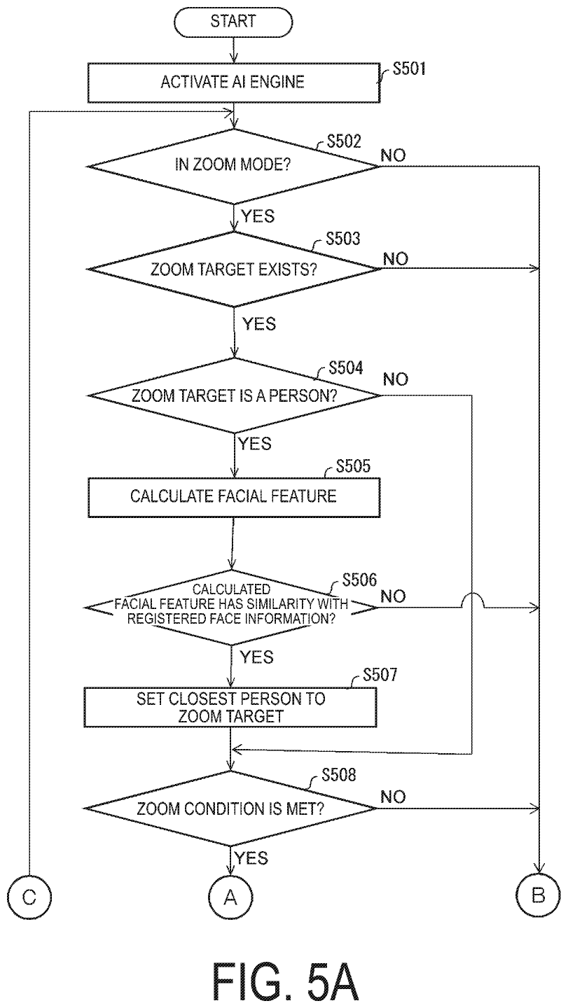

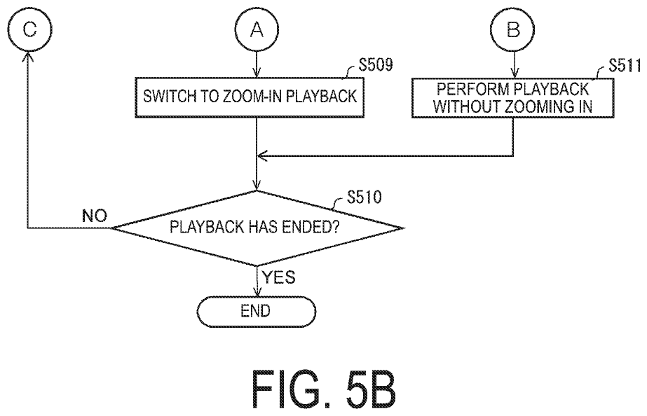

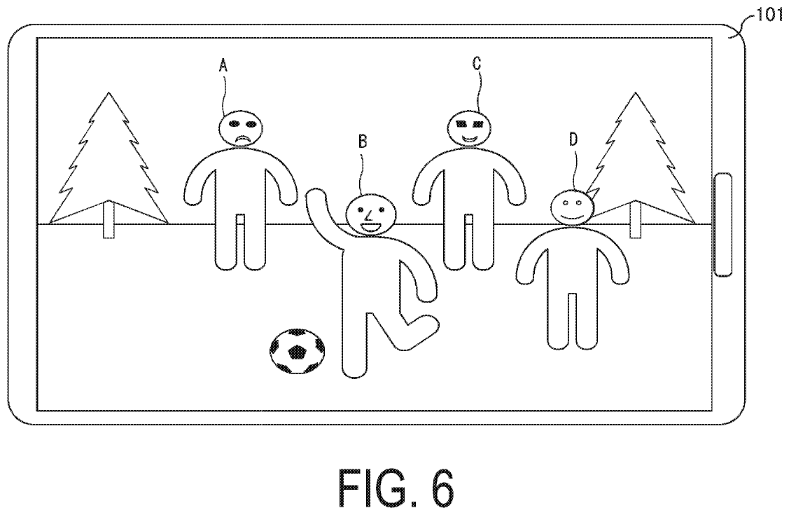

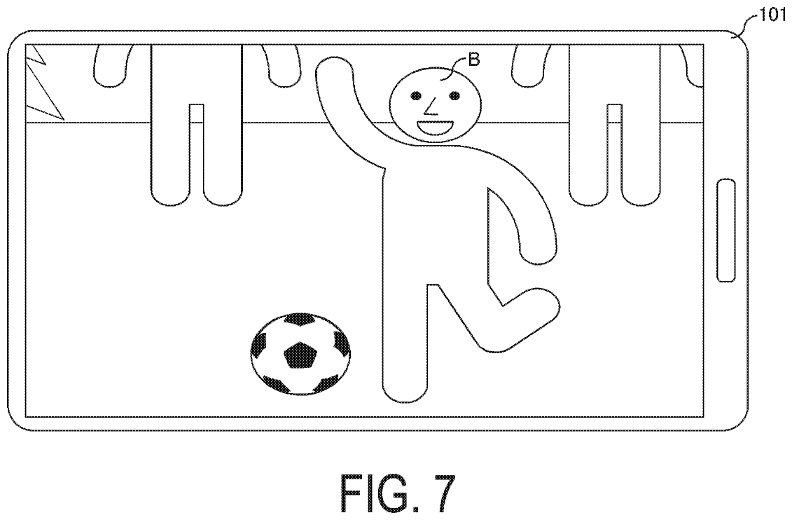

FIGS. 5A and 5B are flowcharts illustrating the display processing of the electronic device according to the first embodiment. FIGS. 6 and 7 are diagrams illustrating a display example of the display unit of the electronic device according to the first embodiment. The display processing of the control unit 121 will be described below with reference to FIGS. 5A to 7.

The display processing of the control unit 121 is started by, for example, the user running a video playback application software (video playback app) installed on the electronic device 101. Note that the moving image 174 captured by the camera 111 is stored in the storage unit 171. When the video playback app is run, the display control unit 141 plays the moving image 174. In other words, the display control unit 141 displays the moving image 174 stored in the storage unit 171 at the default size with no zoom on the display unit 181.

Then, in the processing to display the moving image 174 on the display unit 181, the display control unit 141 switches between an overall display of the moving image 174 and a magnified display of the subject included in the moving image 174 in response to an operation by the user while playing the moving image 174. The display control unit 141 uses the AI engine 153 to play the moving image 174 zoomed in on the set region in response to the video playback processing transitioning to a zoom mode that provides a magnified display of the subject in the moving image 174.

Step S501

The control unit 121 activates the AI engine 153.

Step S502

The control unit 121 determines whether the video playback processing is in zoom mode. The control unit 121, for example, displays a zoom-in playback button on the display unit 181 for the user to operate to display a magnified display of the subject. Then, in a case where the user touches the zoom-in playback button, the video playback processing of the control unit 121 transitions to the zoom mode. Note that, when the user touches the zoom-in playback button again or when the zoom-in playback has continued for a predetermined amount of time, the zoom mode is canceled.

In a case where the video playback processing is in the zoom mode (YES in step S502), the control unit 121 executes the determination of step S503. In other words, in the processing to extract the subjects and information relating to each subject from the moving image, the extraction unit 152 extracts the subjects and information relating to each subject from the moving image 174 in response to switching to a magnified display of the subject included in the moving image 174 (extraction step). On the other hand, in a case where the video playback processing is not in the zoom mode (NO in step S502), the control unit 121 executes the processing of step S511.

Step S503

The extraction unit 152 uses the AI engine 153 activated in step S501 to determine whether a zoom target exists in the frame of the moving image 174 during playback at that time.

For example, the AI engine 153 may determine whether the composition in the magnified image of the moving image 174 is good (whether an evaluation value relating to the composition is equal to or greater than a predetermined value). A “magnified image of the moving image 174” refers to a magnified image of the region including the object, person, or the like extracted by the AI engine 153.

Additionally, the AI engine 153 determines whether there is a specific object, such as a person, dog, or cat in the moving image 174. Note that the control unit 121 may determine whether a zoom target exists by a different method to that described above.

In a case where the zoom target exists in the moving image 174 (YES in step S503), the control unit 121 executes the determination of step S504. In a case where the zoom target does not exist in the moving image 174 (NO in step S503), the control unit 121 executes the processing of step S511.

Step S504

The AI engine 153 determines whether the zoom target determined to exist in step S503 is a person. In a case where the zoom target is determined to be a person (YES in step S504), the control proceeds to step S505, and in a case where the zoom target is determined to not be a person (NO in step S504), the control proceeds to step S508. The AI engine 153 determines that the zoom target is a person when a human face can be detected from the zoom target, for example.

Step S505

The AI engine 153 calculates the facial feature of the person who is the zoom target. Note that, in a case where there are a plurality of persons who are zoom targets, the AI engine 153 calculates the facial feature of each person. For example, as illustrated in FIG. 6, in the frame of the moving image 174 displayed on the display unit 181, persons A to D are shown. In a case where the persons A to D are zoom targets, the AI engine 153 calculates the facial feature of each person A to D.

Step S506

The AI engine 153 determines whether there is a facial feature with a high similarity to the facial feature calculated in step S505 in the registered face information 173. For example, in a case where the distance (Euclidean distance, for example) between the facial feature calculated in step S505 and one of the facial features in the registered face information 173 is equal to or less than a predetermined threshold value, the AI engine 153 determines that there is a facial feature with high similarity to the facial feature calculated in step S505 in the registered face information 173. In a case where a facial feature with high similarity to the facial feature calculated in step S505 is determined to be in the registered face information 173 (YES in step S506), the control proceeds to step S507. In a case where a facial feature with high similarity to the facial feature calculated in step S505 is determined to not be in the registered face information 173 (NO in step S506), the control proceeds to step S511. Note that in a case where there are a plurality of persons who are zoom targets and a plurality of facial features are calculated in step S505, for each facial feature, the AI engine 153 determines whether there is a facial feature with a high similarity in the registered face information 173, and, in a case where there is one or more facial features with a high similarity, the control proceeds to step S507.

Step S507

The AI engine 153 sets, as the zoom target, the person with the face used in calculating the facial feature determined to have a high similarity to a facial feature in the registered face information 173. Also, in a case where a plurality of facial features have been determined to have a high similarity to a facial feature in the registered face information 173, from among the facial features in the registered face information 173 determined to have a high similarity to one of the plurality of facial features, the person with the face used to calculate the facial feature determined to have a high similarity to the facial feature corresponding to the highest priority is set as the zoom target. Also, persons other than the zoom target person set in step S507 are excluded from being the zoom target. For example, in a case where, from among the persons A to D in the frame of the moving image illustrated in FIG. 6, the facial features of the person A and the person C are determined to not be facial features with high similarity in the registered face information 173, the facial feature of the person B is determined to have high similarity to the facial feature corresponding to a priority of 3 in the registered face information 173 illustrated in FIG. 4, and the facial feature of the person D is determined to have high similarity to the facial feature corresponding to a priority of 2 in the registered face information 173 illustrated in FIG. 4, the AI engine 153 sets, as the zoom target, the person B with the facial feature determined to have high similarity to the facial feature with the highest priority (in other words, a priority of 3). Additionally, the AI engine 153 excludes the persons A, C, and D from being the zoom target. The person B with the facial feature determined to have high similarity to the facial feature with the highest priority is the person, from among the persons A to D, present most in the still images 172-1 to 172-m and is likely the person most friendly with the user from among the persons A to D.

Step S508

The control unit 121 uses the AI engine 153 to determine whether one or more zoom targets satisfy the zoom condition. This involves further determining whether one or more of the zoom targets determined to exist in the frame of the moving image 174 in step S503 should be actually displayed in a magnified display. Note that in a case where the zoom target determined to exist in the frame of the moving image 174 in step S503 is a person (YES in step S504), the AI engine 153 determines whether the zoom condition is satisfied by the zoom target set in step S507.

For example, the AI engine 153 calculates a score for each zoom target for each of the conditions described below. The extraction unit 152 outputs the calculated score to the selection unit 151. The selection unit 151 applies weighting according to the order of priority described below to find the total of the scores for each zoom target and determine whether each zoom target satisfies the zoom condition using the total score. Specifically, the selection unit 151 may evaluate the size of the subject, the position of the subject, whether the subject has a face, and the facial expression of the subject to calculate the score for each zoom target.
Size of the subject (predetermined size or greater)
Position where the subject is present (near the center of the overall image)
Whether the subject has a face (whether a face is included)
Facial expression of the subject (whether they are smiling)
Movement of the subject
Orientation of the subject
Number of subjects
Brightness of the subject
Composition of the subject

In a case where at least one of the zoom targets is determined to satisfy the zoom condition (YES in step S508), the control unit 121 executes the processing of step S509. In a case where none of the zoom targets are determined to satisfy the zoom condition (NO in step S508), the control unit 121 executes the processing of step S511. Note that the processing to further determine whether one or more of the zoom targets in step S508 should be actually displayed as a magnified display may be omitted, calculating the score may be omitted, and the selection unit 151 may always determine that a zoom target satisfies the zoom condition.

Step S509

The selection unit 151 selects the actual magnified display target from among the one or more zoom targets that satisfy the zoom condition (selection step). The selection unit 151 may select a zoom target with a high total score for each condition calculated in step S508. Furthermore, the zoom target set in step S507 may be selected as the actual magnified display target. For example, among the persons A to D illustrated in FIG. 6, the person B with a facial feature determined to have high similarity to the facial feature with the highest priority set as the zoom target may be selected as the actual magnified display target.

Then, the selection unit 151 outputs zoom region information of the selected magnified display target to the display control unit 141. For example, the zoom region information indicating a rectangular region including the person B or the face of the person B set as the zoom target in step S507 is output to the display control unit 141. The display control unit 141 acquires the zoom region information from the selection unit 151 and switches from playback of the moving image 174 to zoom-in playback with a magnified display of the region including the magnified display target in accordance with the zoom region information (display control step). For example, the display control unit 141 switches to the screen illustrated in FIG. 7. As illustrated in FIG. 7, the person B set as the zoom target in step S507 is displayed magnified. The zoom-in playback displaying the region including the magnified display target magnified is an example of predetermined processing.

Note that during the zoom-in playback, using the AI engine 153, the display control unit 141 tracks the selected magnified display target and displays the region including the magnified display target magnified on the display unit 181.

In a case where the magnified display target is not present in the frame of the moving image 174, the control unit 121 again executes the processing of steps S503 to S508. In a case where a new magnified display target is specified, the display control unit 141 performs zoom-in playback. When a zoom target does not exist or the zoom condition is not satisfied, the display control unit 141 cancels the zoom mode and performs video playback at the default size.

Step S510

The control unit 121 determines whether to end video playback. For example, the control unit 121 determines whether the user has performed an operation instructing playback to end on the screen of the video playback app.

In the case of ending video playback (YES in step S510), the control unit 121 ends the video playback app and ends the series of video playback processing. In the case of not ending video playback (NO in step S510), the control returns to step S502.

Note that the control unit 121 may execute the processing of steps S503 to S508 at predetermined intervals. In this manner, the zoom target can be switched depending on the moving image situation at predetermined intervals.

Step S511

In a case where the video playback processing is not the zoom mode, a zoom target does not exist in the moving image 174, or the moving image 174 does not satisfy the zoom condition, the control unit 121 executes no processing and the selection unit 151 outputs nothing to the display control unit 141. Accordingly, the display control unit 141 continues playback at the default size without zooming in.

With the electronic device according to the first embodiment, it can be determined whether a person included in a moving image is a person friendly with the user on the basis of persons present in still images. In this manner, the electronic device can provide a magnified display of a person friendly with the user shown in the moving image. Furthermore, in a case where there are a plurality of persons present in the same frame of the moving image, the person closest to the user from among the plurality of persons can be displayed magnified.

Additionally, the display control unit 141 may display a frame around the person friendly with the user present in the moving image or the person most friendly with the user from among the plurality of persons instead of the magnified display or simultaneously with the magnified display. In addition, the display control unit 141 may execute processing for a facial feature to blur out the person (for example, the persons A and C in FIG. 6) determined to not have a facial feature with a high similarity in the registered face information 173 in the display and display the person in the default manner (for example, the persons B and D in FIG. 6) determined to have a facial feature with a high similarity in the registered face information 173 to display the person friendly with the user in a clear manner. Additionally, the AI engine 153 may execute the processing of steps S503 to S507 during moving image capture by the camera 111. In this case, in a case where the AI engine 153 determines whether the facial feature of a person present in the moving image has high similarity to the facial feature in the registered face information 173 and the facial feature is determined to have high similarity, processing may be executed so that the display control unit 141 displays a frame around the person or the control unit 121 focuses the camera 111 on the person, thus letting the user know that a person friendly with the user is present in the moving image. Additionally, the AI engine 153 may, in the storage unit 171, store the information of the position of the frame around the person in each moving image frame separate from the data of the moving image being captured. In this case, upon video playback after capturing the moving image, the display control unit 141 can use the information of the position stored in the storage unit 171 to playback a moving image in which the person is displayed zoomed in.

### Second Embodiment

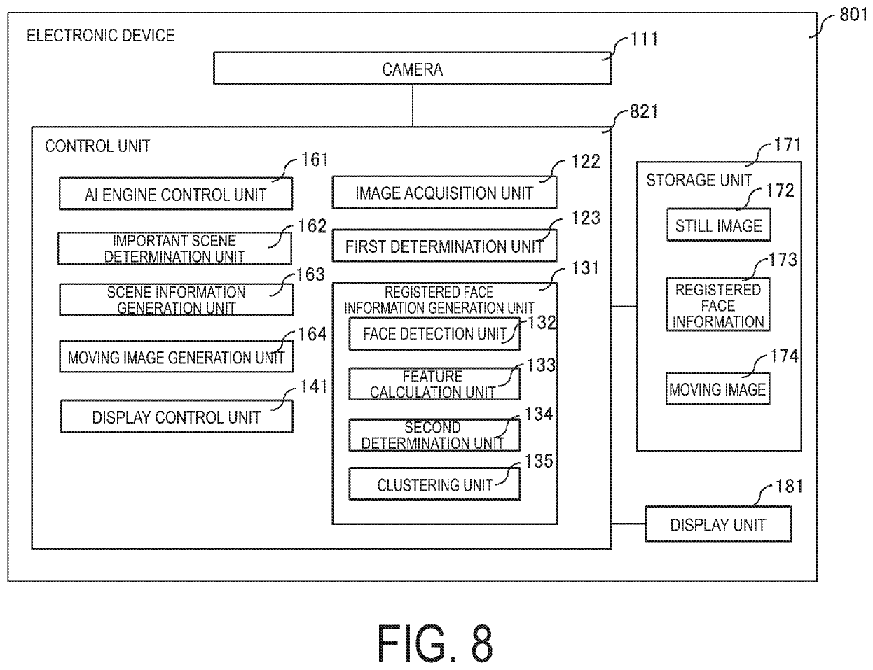

FIG. 8 is an example of a configuration diagram of an electronic device according to the second embodiment.

An electronic device 801 includes the camera (image capture unit) 111, a control unit 821, the storage unit 171, and the display unit 181.

The camera 111, the storage unit 171, and the display unit 181 of the second embodiment have the same function and configuration as the camera 111, the storage unit 171, and the display unit 181 of the first embodiment, and thus descriptions thereof are omitted.

The control unit 821 controls the electronic device 801. The control unit 821 can execute various types of application software (not illustrated) stored in the storage unit 171. The control unit 821 includes the image acquisition unit 122, the first determination unit 123, the registered face information generation unit 131, the display control unit 141, an AI engine control unit 161, an important scene determination unit 162, a scene information generation unit 163, and a moving image generation unit 164.

The image acquisition unit 122, the first determination unit 123, and the registered face information generation unit 131 of the second embodiment have the same function and configuration as the image acquisition unit 122, the first determination unit 123, and the registered face information generation unit 131 of the first embodiment, and thus descriptions thereof are omitted. The registered face information generation unit 131 of the second embodiment generates the registered face information 173 in a similar manner to in the first embodiment.

The AI engine control unit 161 functions as an AI engine that operates artificial intelligence (AI). The data and the like learned by the artificial intelligence may be stored in the storage unit 171.

For each frame included in the captured moving image (first moving image) or for each scene, i.e., a plurality of continuous frames included in the captured moving image, the AI engine control unit 161 calculates a score (evaluates an importance) on the basis of the frame or the image information in the scene. Here, the image information is information related to each frame or the scene and may be, for example, at least one of a subject, a composition, or a color tone. Note that the captured moving image may be a moving image being captured by the camera 111 or may be the captured moving image 174 stored in the storage unit 171.

In a case where, for example, the score is calculated on the basis of the subject included in the captured moving image, the score is calculated using a reference that the artificial intelligence has pre-learned on the basis of the type of subject (whether subject is a person or a specific object such as an animal), the size, the movement, the position, the orientation, the number, the brightness, or the like.

As a specific example, the AI engine control unit 161 may calculate a higher score when the type of the subject is a person as compared to when the subject is not a person. In addition, in a case where the subject is a human (person) and there is a facial feature with high similarity to a feature of the face of the person in the registered face information 173, the AI engine control unit 161 may set the person as a specific subject. In addition, in a case where the subject is a human (person) and there is a facial feature with high similarity to a feature of the face of the person in the registered face information 173, the AI engine control unit 161 may calculate a higher score. The AI engine control unit 161 may calculate a higher score when the expression of the person is a smile. Note that what type of subject a high score is calculated for may be set by the user. According to such a configuration, the user can appropriately set different references for calculating the score depending on whether they are capturing a moving image with a person as the target or whether they are capturing a moving image with a target such as an animal that is not a person.

Similarly, in a case where the AI engine control unit 161 calculates the score on the basis of the composition included in the captured moving image, the score is calculated in accordance with a reference that is pre-learned by the artificial intelligence. For example, the AI engine control unit 161 may calculate a higher score for compositions that more closely obey the rule of thirds or other compositions considered to be generally good.

The information of the score for each frame or scene calculated by the AI engine control unit 161 is output to the important scene determination unit 162 described below.

The important scene determination unit 162 determines whether the frame or the scene is an important scene from the score for each frame or scene included in the captured moving image calculated by the AI engine control unit 161. In other words, the important scene determination unit 162 executes important scene determination processing to determine whether each frame included in the captured moving image is an important scene on the basis of the image information included in the captured moving image. Additionally, the important scene determination unit 162 determines whether each frame or scene is an important scene on the basis of at least one of the subject, the composition, or the color tone relating to the image included in the captured moving image.

The important scene determination unit 162 determines whether a frame or scene is an important scene by determining whether the score is equal to or greater than a predetermined threshold value. The predetermined threshold value corresponds to the score calculation criterion of the AI engine, and the important scene determination unit 162 sets the criterion to an appropriate value. Furthermore, the user may set the predetermined threshold value to a discretionary value. Accordingly, the user can adjust the number of frames or scenes that are determined to be important scenes by changing the predetermined threshold value.

Additionally, in a case where the length of a cut-out moving image (second moving image) described below is set in advance, the important scene determination unit 162 may appropriately adjust the predetermined threshold value so that the length of the moving image, which is the combined total of all important scenes, is substantially the same as the length of the set length of the cut-out moving image. In this manner, the important scene determination unit 162 can extract an important scene from the captured moving image so that the cut-out moving image is a moving image with a predetermined length.

Note that the function of the AI engine in the AI engine control unit 161 may be included in the important scene determination unit 162. In such a case, the important scene determination unit 162 executes both the processing to calculate the score of each frame or scene included in the captured moving image and the processing to determine whether the frame or scene is an important scene.

As described above, with the important scene determination unit 162, which portions of the captured moving image are important scenes can be determined on the basis of the image included in the captured moving image.

The scene information generation unit 163 executes scene information generation processing to generate important scene information including the determination result of whether each frame or scene included in the captured moving image is an important scene on the basis of the determination result from the important scene determination unit 162. The important scene information may be directly tagged with information indicating whether each frame of the captured moving image is an important scene.

In addition, the scene information generation unit 163 may generate, as important scene information, information identifying a frame determined to be an important scene separately from the data of the captured moving image. According to such a configuration, the electronic device 801 can separate and manage the captured moving image and the important scene information.

The information identifying the frame may be information relating to a point in time when the frame determined to be an important scene in the captured moving image exists in the captured moving image or may be information indicating the order of the frame in the captured moving image. Note that with a configuration in which the point in time when the frame exists in the captured moving image is information identifying the frame, even in a case where the frame rate of the captured moving image is changed after the fact, the position where the frame determined to be an important scene exists in the captured moving image does not change. Thus, it is not necessary to change the important scene information relating to the captured moving image.

The moving image generation unit 164 generates a cut-out moving image (second moving image) obtained by cutting out an important scene from the captured moving image. In other words, the moving image generation unit 164 extracts, as a frame for connection, a frame determined to be an important scene from the captured moving image on the basis of the important scene information generated by the scene information generation unit 163. Then, the moving image generation unit 164 executes moving image generation processing to generate the second moving image formed of a single frame for connection or a plurality of frames for connection that are connected.

According to such a configuration, the moving image generation unit 164 can generate a cut-out moving image which is shorter than the captured moving image and which includes only the important scene. Accordingly, the user can obtain a cut-out moving image having a short length and a small data size. Therefore, the user can easily manage the moving image stored in the electronic device 801.

Note that after generating the cut-out moving image, the control unit 821 may store the captured moving image in the storage unit 171 as the moving image 174 and may further store the cut-out moving image in the storage unit 171.

Furthermore, the moving image generation unit 164 may further extract, as a frame for connection, a frame that satisfies a predetermined condition from among the frames determined to be an important scene by the important scene determination unit 162. Here, the predetermined condition may be, for example, a condition such as the expression of the subject, the composition, or the amount of movement relating to frames that is applied only in a case where a certain number or greater of continuous frames are determined to be important scenes.

Specifically, for the series of frames determined to be important scenes, the moving image generation unit 164 may extract, as frames for connection, more frames in a case where the expression of the subject is a smile than in a case where the expression of the subject is not a smile. According to such a configuration, the moving image generation unit 164 can change the number of frames in the continuous series of frames determined to be an important scene in accordance with the predetermined condition. Thus, the moving image generation unit 164 can adjust the length of a scene including the same subject or composition, and thus can generate a cut-out moving image of content more preferred by the user including various scenes shown in a short amount of time.

The predetermined condition is not limited to that in the example described above and may be any condition. Various predetermined conditions may be preset in the electronic device 801, or the user may discretionarily set the predetermined condition. Furthermore, the options of predetermined conditions may be sequentially increased or updated via the communication function included in the electronic device 801.

As described above, according to the configuration in which a frame satisfying a predetermined condition is further extracted as a frame for connection from among the frames determined to be an important scene, the control unit 821 can set a predetermined condition for generating the cut-out moving image without using only the predetermined threshold value for the score obtained via the important scene determination. Thus, because the user can set and change the conditions for generating the cut-out moving image in fine detail, the control unit 821 can generate a cut-out moving image that more closely matches the user's taste.

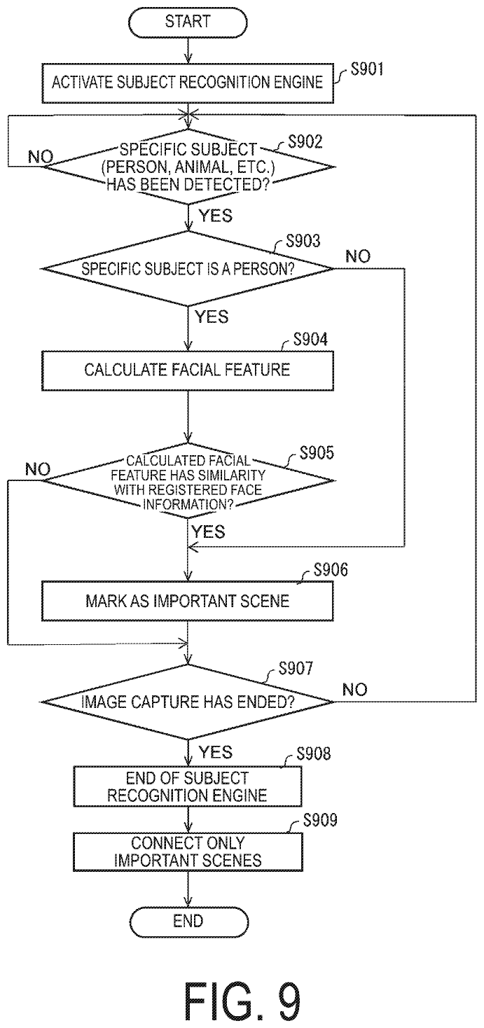

FIG. 9 is a flowchart illustrating a marking processing of the electronic device according to the second embodiment. Note that the registered face information 173 is generated on the basis of the still image 172 and stored in the storage unit 171.

Step S901

The image acquisition unit 122 acquires the captured moving image captured by the camera 111 (moving image acquisition step) and outputs the captured moving image to the AI engine control unit 161. Note that the captured moving image to be acquired may be a moving image being captured or may be the captured moving image 174 stored in the storage unit 171. The AI engine control unit 161 receives an input of the captured moving image and activates a subject recognition engine, which is one example of an AI engine.

Step S902

Subsequently, the AI engine control unit 161 determines whether a specific subject, such as a person or an animal, is included in the image information relating to the frame for each frame included in the captured moving image (step S902). In a case where the specific subject is not included in one frame (NO in step S902), the AI engine control unit 161 executes the determination of step S902 for the next frame. In a case where the specific subject is included in one frame (YES in step S902), the control proceeds to step S903.

Step S903

The AI engine control unit 161 determines whether a specific subject determined to be included in the frame in step S903 is a person. In a case where the specific subject is determined to be a person, the control proceeds to step S904. In a case where the specific subject is determined to not be a person, the control proceeds to step S906.

Step S904

The AI engine control unit 161 calculates the facial feature of the person who is the specific subject. Note that, in a case where there are a plurality of persons who are a specific subject in the frame, the AI engine control unit 161 calculates the facial feature of each person.

Step S905

The AI engine control unit 161 determines whether there is a facial feature with a high similarity to the facial feature calculated in step S904 in the registered face information 173. For example, in a case where the distance (Euclidean distance, for example) between the facial feature calculated in step S904 and the facial feature in the registered face information 173 is equal to or less than a predetermined threshold value, the AI engine control unit 161 determines that there is a facial feature with high similarity to the facial feature calculated in step S904 in the registered face information 173. In a case where a facial feature with high similarity to the facial feature calculated in step S904 is determined to be in the registered face information 173, the AI engine control unit 161 sets the person with the face used in calculating the facial feature determined to have a high similarity as the specific subject, and the control proceeds to step S906. In a case where a facial feature with high similarity to the facial feature calculated in step S904 is determined to not be in the registered face information 173, the control proceeds to step S907. Note that in a case where there are a plurality of persons who are zoom targets and a plurality of facial features are calculated in step S904, for each facial feature, the AI engine control unit 161 determines whether there is a facial feature with a high similarity in the registered face information 173, and, in a case where there is one or more facial features with a high similarity, the AI engine control unit 161 sets the person with the face used in calculating the facial feature determined to have high similarity as the specific subject, and the control proceeds to step S906.

Step S906

In a case where the specific subject is a person (YES in step S903) and a facial feature with a high similarity to the facial feature calculated in step S904 is determined to be in the registered face information 173 (YES in step S905), the AI engine control unit 161 calculates a score equal to or greater than the predetermined threshold value for the frame and the important scene determination unit 162 determines that the frame is an important scene (important scene determination step). Also, in a case where the specific subject is not a person (NO in step S903), the AI engine control unit 161 calculates a score equal to or greater than the predetermined threshold value for the frame and the important scene determination unit 162 determines that the frame is an important scene (important scene determination step). Also, when it is determined that a frame is an important scene, the scene information generation unit 163 marks the frame as an important scene by generating important scene information (scene information generation step). Marking is an example of predetermined processing.

Step S907

The important scene determination unit 162 determines whether capture of the captured moving image via the camera 111 has ended. In a case where capture has not ended (NO in step S907), the control unit 821 repeatedly executes the processing of steps S902 to S907 until capture ends. In a case where capture has ended (YES in step S907), the control proceeds to step S908.

Step S908

When capture has ended (YES in step S907), the AI engine control unit 161 ends the subject recognition engine function.

Step S909

Subsequently, the moving image generation unit 164 extracts the frame marked as an important scene from the captured moving image as a frame for connection, connects the frames for connection, and generates a cut-out moving image (another moving image) (moving image generation step). The processing to extract the frame marked as an important scene as a frame for connection, connect the frames for connection, and generate a cut-out moving image is an example of predetermined processing.

Note that, herein, an example has been given in which the subject recognition engine calculates a score on the basis of the type of the subject (whether the subject is a specific subject) included in the image information relating to the frame which is the determination target and, in a case where the type of the subject is a person, whether a facial feature with a high similarity to the facial feature of the person is in the registered face information 173. However, the subject recognition engine is not limited thereto, and the score may be calculated on the basis of any characteristic of the subject.

After the marking processing in FIG. 9, the display control unit 141 executes the processing to display and playback the cut-out moving image on the display unit 181. The display control unit 141 may impart a transition effect such as fade-out to the cut-out moving image during playback. Furthermore, the display control unit 141 may playback only specific frames for connection in the cut-out moving image for a certain amount of time.

With the electronic device according to the second embodiment, registered face information can be generated on the basis of the persons present in the still image, and it can be determined whether a person included in a moving image is a person friendly with the user on the basis of the registered face information. In this manner, the electronic device can mark a frame of the captured image including a person friendly with the user as an important scene. With the electronic device according to the second embodiment, a frame of the captured moving image including a person friendly with the user can be marked as an important scene, and marked frames can be connected to generate a cut-out moving image. In other words, with the electronic device according to the second embodiment, a digest moving image including scenes extracted from the captured moving image including a person friendly with the user can be generated.

Implementation Example by Software

A control block (in particular, the control unit 121, 821) of the electronic device 101, 801 may be realized by a logic circuit (hardware) formed in an integrated circuit (IC chip) or the like, or by software by using a central processing unit (CPU). In the latter case, the electronic device 101, 801 includes a CPU in which a command of a program, that is, software to realize each function is executed, a ROM or a storage device (these are referred to as “recording medium”) in which the program and various types of data are recorded in a manner capable of being read by a computer (or CPU), and a RAM to develop the program. Then, the computer (or CPU) reads the program from the recording medium, executes the program, and operates as the control unit 121 to achieve the object of the disclosure. As the recording medium, a “non-transitory tangible medium”, such as a tape, a disk, a card, a semiconductor memory, or a programmable logic circuit may be used. Further, the program may be supplied to the computer via any transmission medium capable of transmission.

Note that the disclosure is not limited to the above-described embodiments and may be modified, and an above-described configuration can be replaced by substantially the same configuration, a configuration that achieves substantially the same operation and effect, or a configuration that can achieve the same object.

For example, in the first and second embodiments, whether a person friendly with the user is in the moving image is determined (specifically, whether a facial feature with high similarity to a facial feature of a person present in the moving image is in the registered face information 173 is determined). However, a still image that is not the still image used in the generation of the registered face information 173 may be used, and whether a person friendly with the user is present in the still image that is not the still image used in the generation of the registered face information 173 may be determined.

Furthermore, the display processing of the first embodiment and the marking processing of the second embodiment are not limited to being execute during moving image capture or during moving image playback and may be executed at a different time.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An electronic device, comprising:
a storage unit configured to store a still image; and
a control unit,
wherein the control unit
calculates a feature of each one of a plurality of faces included in the still image,
groups the features of the plurality of faces into one or more groups by clustering on the basis of similarity of the features,
selects one feature from the features included in each group of the one or more groups,
stores registered face information including the selected feature of each group in the storage unit,
calculates a feature of at least one face included in a moving image, and
executes predetermined processing on the moving image on the basis of the feature of the at least one face included in the moving image and the registered face information.

2. The electronic device according to claim 1,
wherein the control unit determines whether the feature of the at least one face included in the moving image and the selected feature included in the registered face information have similarity; and
in a case where the feature of the at least one face included in the moving image and the selected feature included in the registered face information are determined to have similarity, the predetermined processing is executed on a frame including the at least one face of the moving image.

3. The electronic device according to claim 1,
wherein the at least one face included in the moving image is a plurality of faces; and
the control unit
stores the registered face information including the selected feature of each group and a priority based on the clustering associated together in the storage unit,
calculates a feature of each one of the plurality of faces included in the moving image,
determines whether the feature of each one of the plurality of faces and the selected feature included in the registered face information have similarity, and
in a case where the plurality of faces are included in one frame of the moving image and the feature of each one of the plurality of faces and the selected feature included in the registered face information are determined to have similarity, predetermined processing is executed on the basis of a face, from among the plurality of faces, used in calculation of a feature determined to have similarity to a feature associated with a highest priority in the registered face information.

4. The electronic device according to claim 1,
wherein the control unit displays the at least one face included in the moving image magnified on the display unit as the predetermined processing.

5. The electronic device according to claim 1,
wherein the control unit extracts at least two frames from a plurality of frames included in the moving image as frames for connection, connects the frames for connection, and generates another moving image as the predetermined processing.

6. The electronic device according to claim 3,
wherein the priority is set on the basis of a number of features included in each group of the one or more groups.

7. The electronic device according to claim 3,
wherein the control unit displays a face, from among the plurality of faces, used in calculation of the feature determined to have similarity to the feature associated with a highest priority in the registered face information magnified on the display unit as the predetermined processing.

8. A control method, comprising processing to:
calculate a feature of each one of a plurality of faces included in a still image;
group the features of each one of the plurality of faces into one or more groups by clustering on the basis of similarity of the features;
select one feature from the features included in each group of the one or more groups;
store registered face information including the selected feature of each group in the storage unit;
calculate a feature of at least one face included in a moving image; and
execute predetermined processing on the moving image on the basis of the feature of the at least one face included in the moving image and the registered face information.
